(19) United States
(12) Patent Application Publication
(10) Pub. No.: US 2013/0256352 A1
(43) Pub. Date: Oct. 3, 2013

(54) CARGO SUPPORT DEVICE

(71) Applicant: James Barnett, Lehigh Acres, FL (US)

(72) Inventor: James Barnett, Lehigh Acres, FL (US)

(21) Appl. No.: 13/851,074

(22) Filed: Mar. 26, 2013

Related U.S. Application Data
(60) Provisional application No. 61/618,591, filed on Mar. 30, 2012.

(51) Int. Cl. B60R 9/06

(52) U.S. Cl. CPC B60R 9/06
USPC 224/405; 29/525.02

(57) ABSTRACT

A cargo support device that includes a cargo support bar having a top flat bar, a plurality of triangular braces and a pair of mounting plates, the top flat bar receives one or more pieces of cargo that would otherwise be placed on a tailgate of a pick-up truck, the triangular braces are coupled to a bottom portion of the cargo support bar and extend downward into the pick-up truck bed while the cargo support bar is placed across the pick-up truck bed, the pair of mounting plates are coupled underneath a first end of the cargo support bar and a second end of the cargo support bar and the pair of mounting plates are placed on the pair of rails of the pick-up truck bed. The device also includes a pair of mounting clamps to couple the cargo support bar to the sides of the pick-up truck bed.

This application claims priority to U.S. Provisional Application 61/618,591 filed on Mar. 30, 2012, the entire disclosure of which is incorporated by reference.

### BACKGROUND OF THE INVENTION

1. Field of the Invention

The present invention is a support device. More specifically, the present invention is a cargo support device.

2. Description of the Related Art

When loading materials into the bed of a truck, it can be difficult to prevent the tailgate from becoming scratched or dented. Many large items must be placed on the tailgate, which can make it hard to open and close the tailgate in order to load additional items. Each time the tailgate is opened, materials fall, possibly damaging paint or another part of the tailgate. Repairs to the truck can be costly and a more suitable cargo support device is needed.

The present invention allows a user to prevent damage to the tailgate of a truck when loading and unloading cargo. The present invention allows users to open and close the tailgate while the truck is loaded up with materials. It prevents the truck from incurring scratches, dings, and other damage caused by resting heavy materials on the tailgate. The present invention can be used by anyone who hauls supplies and other items in the bed of a truck.

### BRIEF SUMMARY OF THE INVENTION

The present invention is a support device. More specifically, the present invention is a cargo support device.

The cargo support device includes a cargo support bar having a top flat bar, a plurality of triangular braces and a pair of mounting plates, the top flat bar receives one or more pieces of cargo that would otherwise be placed on a tailgate of a pick-up truck, the triangular braces are coupled to a bottom portion of the cargo support bar and extend downward into the pick-up truck bed while the cargo support bar is placed across the pick-up truck bed, the pair of mounting plates are coupled underneath a first end of the cargo support bar and a second end of the cargo support bar and the pair of mounting plates are placed on the pair of rails of the pick-up truck bed. The device also includes a pair of mounting clamps to couple the cargo support bar to the sides of the pick-up truck bed.

It is an object of the present invention to provide a cargo support device that allows a user to place cargo and other items onto the cargo support device in contrast to placing the cargo and other items onto the tailgate of a truck when loading and unloading cargo.

It is an object of the present invention to provide a cargo support device that allows a user to open and close the tailgate of a truck while the truck is loaded up with materials.

It is an object of the present invention to provide a cargo support device that prevents the truck from incurring scratches, dings, and other damage caused by resting heavy materials on the tailgate of the truck.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overhead exploded environmental perspective view of a cargo support device, in accordance with one embodiment of the present invention.

FIG. 2 illustrates a side perspective view of a cargo support bar, in accordance with one embodiment of the present invention.

FIG. 3 illustrates a side view of a mounting clamp, in accordance with one embodiment of the present invention.

FIG. 4 illustrates a flowchart of a method for installing a cargo support device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

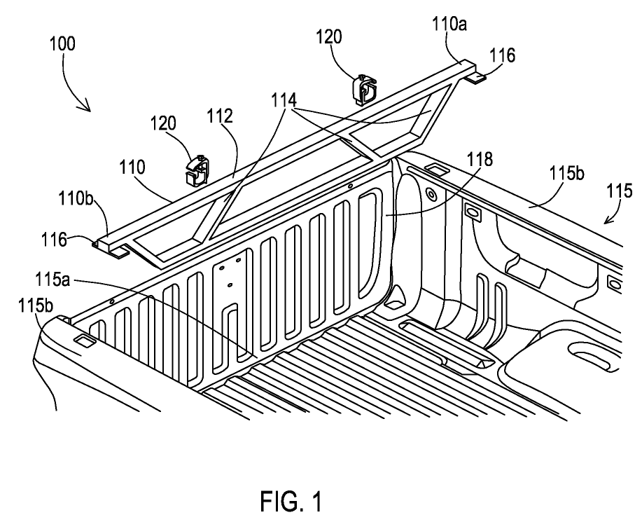

FIG. 1 illustrates an exploded environmental perspective view of a cargo support device 100, in accordance with one embodiment of the present invention. The cargo support device 100 can include a cargo support bar 110 and a pair of mounting clamps 120. The cargo support bar 110 can have a top flat bar 112, a plurality of triangular braces 114 and a pair of mounting plates 116. The top flat bar 112 can receive one or more pieces of cargo or other material (not shown) that a user can place the one or more pieces of cargo or other material on that would otherwise be placed on a tailgate 118 of a pick-up truck 115, thereby possibly causing damage to the tailgate 118. The triangular braces 114 can be coupled to a bottom portion 110a of the cargo support bar 110. The triangular braces 114 can extend downward into the pick-up truck bed 115a while the cargo support bar 110 can be placed across the pick-up truck bed 115a. The pair of mounting plates 116 can be coupled underneath the first end 110a of the cargo support bar 110 and the second end 110b of the cargo support bar 110. The pair of mounting plates 116 can be placed on the rails 115b of the pick-up truck bed 115a. The mounting clamps 120 can be coupled to the pair of mounting plates 116 to couple the cargo support bar 110 to the rails 115b of the pick-up truck bed 115a.

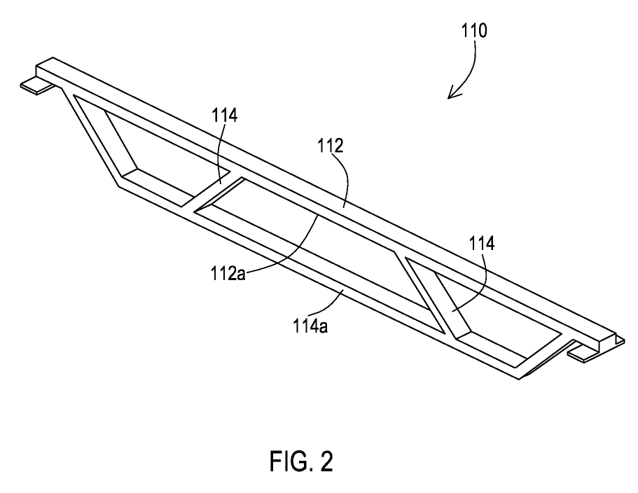

FIG. 2 illustrates a side perspective view of a cargo support bar 110, in accordance with one embodiment of the present invention. The cargo support bar 110 can be made of flat lightweight steel tubing or any other suitable material. The top flat bar 112 is approximately 68 inches in length, approximately 2 inches in width and approximately 1 inch in thickness. The triangular braces 114 can be coupled to the bottom 112a of the top flat bar 112 at approximate 45 degree angles and approximate 135 degree angles. The triangular braces 114 can form a bottom flat bar 114a that is approximately 48 inches in length. The bottom flat bar 114a can also be made of flat lightweight steel tubing or any other suitable material. The triangular braces 114 can extend downward approximately 7-¾ inches or any other suitable distance.

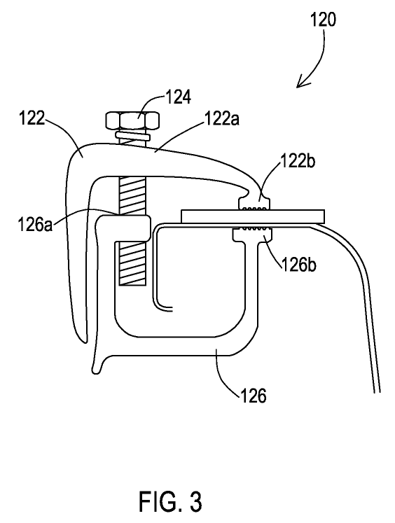

FIG. 3 illustrates a side view of a mounting clamp 120, in accordance with one embodiment of the present invention.

The mounting clamp 120 can have a first clamp arm 122, a threaded attachment bolt 124 and a second clamp arm 126. The first clamp arm 122 can extend over one of the mounting plates 116 and one of the rails 115b of the pick-up truck bed 115a. The first clamp arm 122 can have a first threaded aperture 122a and a first ribbed attachment foot 122b. The second clamp arm 126 can extend underneath one of the mounting plates 116 and the rails 115b of the pick-up truck bed 115a. The second clamp arm 126 can have a second threaded aperture 126a and a second ribbed attachment foot 126b. The first clamp arm 122 and the second clamp arm 126 can be coupled by the threaded attachment bolt 124 that can be screwed through the first threaded aperture 122a and thee second threaded aperture 126a. The threaded attachment bolt 124 can have a head 124a that can be tightened to bring the first ribbed attachment foot 122b and the second ribbed attachment foot 126b together to exert pressure on each of the mounting plates 116 to couple the cargo support bar 110 to each of the rails 115b of the pick-up truck bed 115a.

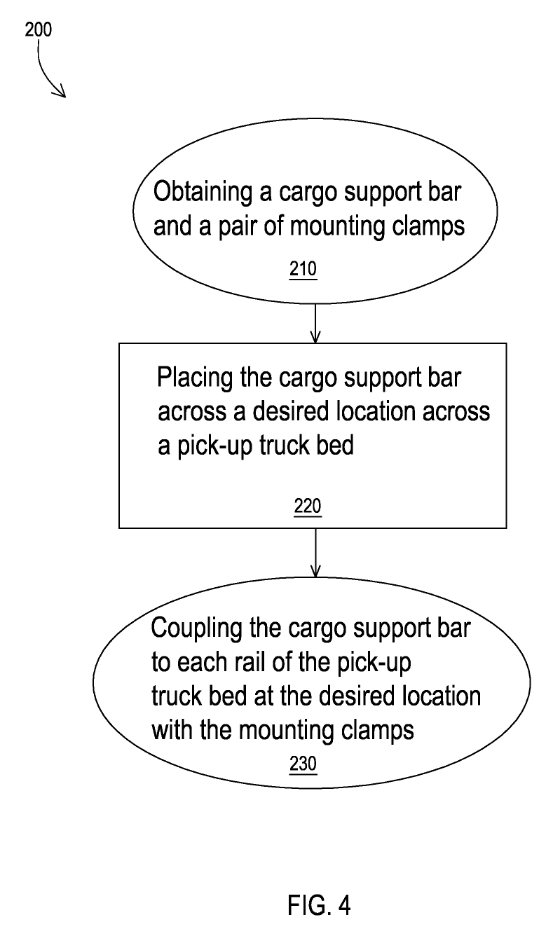

FIG. 4 illustrates a flowchart of a method 200 for installing a cargo support device, in accordance with one embodiment of the present invention. The method 200 includes the steps of obtaining a cargo support bar and a pair of mounting clamps 210, placing the cargo support bar across a desired location across a pick-up truck bed 220 and coupling the cargo support bar to each rail of the pick-up truck bed at the desired location with the mounting clamps 230. The obtaining step 210 includes obtaining a cargo support bar and a pair of mounting clamps from any suitable source such as a retail store or online order source. The placing step 220 includes selecting the desired location to place the cargo support bar to place cargo or other items on in contrast to placing the cargo or other suitable items onto a tailgate of the pick-up truck to possibly damage the tailgate. The coupling step 230 includes understanding how the mounting clamps couple the cargo support bar to each of the rails of the pick-up truck bed and coupling the cargo support bar to the desired location on each of the sides of the pick-up truck with the mounting clamps.

The cargo support device is designed to protect a tailgate from damage that is caused by cargo or other suitable loads. The cargo support device includes an approximate two inch by one inch piece of durable, but lightweight steel tubing with a plurality of triangular braces at the bottom. The braces provide additional stability to allow the cargo support device to withstand more weight, but still be light enough for handling. The cargo support device can be placed on the truck's bed rails along the tailgate. Relatively heavy materials may be placed on the cargo support device instead of on the tailgate itself. The tailgate may still be opened and closed while the cargo support device is in place. The exact specifications of the cargo support device may vary according to the size and dimensions of the pick-up truck being utilized in combination with the cargo support device.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A cargo support device, comprising:
a cargo support bar having a top flat bar, a plurality of triangular braces and a pair of mounting plates, the top flat bar receives one or more pieces of cargo that would otherwise be placed on a tailgate of a pick-up truck; and
a pair of mounting clamps coupled to the pair of mounting plates to couple the cargo support bar to a pair of rails of a pick-up truck bed.

2. The cargo support device according to claim 1, wherein the top flat bar is 68 inches in length, 2 inches in width and 1 inch in thickness.

3. The cargo support device according to claim 1, wherein the triangular braces are coupled to a bottom portion of the cargo support bar.

4. The cargo support device according to claim 1, wherein the triangular braces extend downward into the pick-up truck bed while the cargo support bar is placed across the pick-up truck bed.

5. The cargo support device according to claim 1, wherein the triangular braces are coupled to the bottom of the top flat bar at 45 degree angles and 135 degree angles.

6. The cargo support device according to claim 1, wherein the pair of mounting plates are coupled underneath a first end of the cargo support bar and a second end of the cargo support bar.

7. The cargo support device according to claim 1, wherein the pair of mounting plates are placed on the pair of rails of the pick-up truck bed.

8. The cargo support device according to claim 1, wherein the cargo support bar is made of flat lightweight steel tubing.

9. A cargo support device, comprising:
a cargo support bar having a top flat bar, a plurality of triangular braces and a pair of mounting plates, the top flat bar receives one or more pieces of cargo, the triangular braces are coupled to a bottom portion of the cargo support bar and extend downward into a pick-up truck bed while the cargo support bar is placed across the pick-up truck bed, the pair of mounting plates are coupled underneath a first end of the cargo support bar and a second end of the cargo support bar and the pair of mounting plates are placed on a pair of rails of the pick-up truck bed; and
a pair of mounting clamps coupled to the pair of mounting plates to couple the cargo support bar to the pair of rails of the pick-up truck bed, the pair of mounting clamps have a first clamp arm, a threaded attachment bolt and a second clamp arm, the first clamp arm has a first threaded aperture and a first ribbed attachment foot and the second clamp arm has a second threaded aperture and a second ribbed attachment foot.

10. The cargo support device according to claim 9, wherein the top flat bar is 68 inches in length and 2 inches in width.

11. The cargo support device according to claim 10, wherein the top flat bar is 1 inch in thickness.

12. The cargo support device according to claim 9, wherein the triangular braces are coupled to the bottom of the top flat bar at 45 degree angles and 135 degree angles.

13. The cargo support device according to claim 9, wherein the cargo support bar is made of flat lightweight steel tubing.

14. The cargo support device according to claim 9, wherein the first clamp arm extends over one of the mounting plates and one of the rails of the pick-up truck bed.

15. The cargo support device according to claim 9, wherein the second clamp arm extends underneath one of the mounting plates and the rails of the pick-up truck bed.

16. The cargo support device according to claim 9, wherein the first clamp arm and the second clamp arm are coupled by the threaded attachment bolt that is screwed through the first threaded aperture and the second threaded aperture.

17. The cargo support device according to claim 16, wherein the threaded attachment bolt has a head that is tightened to bring the first ribbed attachment foot and the second ribbed attachment foot together to exert pressure on each of the mounting plates to couple the cargo support bar to each of the rails of the pick-up truck bed.

18. The cargo support device according to claim 9, wherein the triangular braces form a bottom flat bar that is 48 inches in length.

19. A method for installing a cargo support device, comprising the steps of:
obtaining a cargo support bar and a pair of mounting clamps;
placing the cargo support bar across a desired location across a pick-up truck bed; and
coupling the cargo support bar to each rail of the pick-up truck bed at the desired location with the mounting clamps.

20. The method according to claim 19, wherein the placing step includes selecting the desired location to place the cargo support bar to place cargo or other items on in contrast to placing the cargo or other items onto a tailgate of a pick-up truck to possibly damage the tailgate.
